(19) United States
(12) Patent Application Publication
(10) Pub. No.: US 2021/0301573 A1
(43) Pub. Date: Sep. 30, 2021

(54) WIRE REGULATOR

(71) Applicant: SHIROKI CORPORATION, Fujisawa-shi (JP)

(72) Inventors: Kenji YAMAMOTO, Fujisawa-shi (JP); Kazuya YOKOYAMA, Fujisawa-shi (JP)

(73) Assignee: SHIROKI CORPORATION, Fujisawa-shi (JP)

(21) Appl. No.: 17/195,745

(22) Filed: Mar. 9, 2021

(30) Foreign Application Priority Data
Mar. 30, 2020 (JP) 2020-060527

(51) Int. Cl. E05D 15/16

(52) U.S. Cl. CPC E05D 15/165; E05Y 2900/55; E05Y 2201/684; E05Y 2201/64

(57) ABSTRACT

In a wire regulator, a slider has a metal portion and a resin portion. The resin portion covers part of a front surface and a back surface of the metal portion, and forms a rainwater guide portion having an eave, the rainwater guide portion reducing entrance of rainwater into a lifting wire end housing portion, a lowering wire end housing portion, and a groove portion. A slit is provided at the resin portion at at least one of a front surface or a back surface of the slider.

### CROSS-REFERENCE TO RELATED APPLICATION

This application claims priority from Japanese Patent Application No. 2020-060527 filed with the Japan Patent Office on Mar. 30, 2020, the entire content of which is hereby incorporated by reference

### BACKGROUND

### 1. Technical Field

One aspect of the present disclosure relates to a wire regulator.

### 2. Related Art

Generally, a regulator configured to open/close a window glass of a vehicle is provided in a space between an inner panel and an outer panel of a door.

The regulator includes a wire regulator. The wire regulator has a guide rail along a window glass lifting/lowering direction, a slider attached to a window glass and movably engaging with the guide rail, a lifting wire, a lowering wire, and a driver. One end of the lifting wire is locked at a wire end housing portion of the slider. The lifting wire is biased in the direction of tightening the wire, and extends upward of the slider. One end of the lowering wire is locked at the wire end housing portion of the slider. The lowering wire is biased in the direction of tightening the wire, and extends downward of the slider. The driver drives a drum around which the lifting wire is wound and a drum around which the lowering wire is wound. The driver draws the lowering wire and the lifting wire, which are wound around the drums, out of the drums or winds the lowering wire and the lifting wire around the drums, and in this manner, the slider is lifted/lowered along the guide rail.

In some cases, in this wire regulator, the guide rail or the lowering wire rusts due to the downward flow of rainwater and the like, which enter the inside of a door along the window glass, along the guide rail, the slider, the lowering wire, and the like.

For reducing such rusting, the technique of providing an eave (a rain gutter) at the slider has been disclosed (see Japanese Patent No. 6523962). This eave guides rainwater and the like having entered the inside of the door to a position at which no rainwater and the like reach the guide rail and the lowering wire.

For reducing the weight of the wire regulator, the slider is, in some cases, manufactured as an insert molded article of a resin member and a metal member, the insert molded article having an eave.

### SUMMARY

A wire regulator incudes: a guide rail along a window glass lifting/lowering direction; a slider attached to a window glass and movably engaging with the guide rail; a lifting wire locked at the slider at one end and extending upward of the slider; and a lowering wire locked at the slider at one end and extending downward of the slider. The slider is lifted/lowered along the guide rail by movement of the lifting wire and the lowering wire along the guide rail, the slider has a metal portion and a resin portion, the resin portion covers part of a front surface and a back surface of the metal portion, and forms a rainwater guide portion having an eave, the rainwater guide portion reducing entrance of rainwater into a lifting wire end housing portion, a lowering wire end housing portion, and a groove portion, and a slit is provided at the resin portion at at least one of a front surface or a back surface of the slider.

### BRIEF DESCRIPTION OF THE DRAWINGS

FIG. 1 is an enlarged view of a slider illustrated in FIG. 6 which is a front view of a wire regulator of the present embodiment;

FIG. 2 is a left side view of the slider illustrated in FIG. 1;

FIG. 3 is a right side view of the slider illustrated in FIG. 1;

FIG. 4 is a perspective view of the slider illustrated in FIG. 1 from the right side;

FIG. 5 is a perspective view of the slider illustrated in FIG. 1 from the left side;

FIG. 6 is the front view of the wire regulator of the present embodiment;

FIG. 7 is a left side view of the wire regulator illustrated in FIG. 6; and

FIG. 8 is a right side view of the wire regulator illustrated in FIG. 6.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In the insert molded article, a thermal shrinkage amount of the member at a cooling step after or during insert molding varies due to a difference in the coefficient of linear expansion between the resin member and the metal member. Thus, there is a probability that due to the thermal shrinkage amount difference, internal stress is caused at each member and the resin member is cracked.

One object of the present disclosure is to provide a wire window regulator configured so that cracking of a resin portion of a slider can be reduced.

A wire regulator according to an aspect of the present disclosure (this wire regulator) incudes: a guide rail along a window glass lifting/lowering direction; a slider attached to a window glass and movably engaging with the guide rail; a lifting wire locked at the slider at one end and extending upward of the slider; and a lowering wire locked at the slider at one end and extending downward of the slider. The slider is lifted/lowered along the guide rail by movement of the lifting wire and the lowering wire along the guide rail, the slider has a metal portion and a resin portion, the resin portion covers part of a front surface and a back surface of the metal portion, and forms a eave portion which reduces entrance of rainwater into a lifting wire end housing portion, a lowering wire end housing portion, and a groove portion, and a slit is provided at the resin portion at at least one of a front surface or a back surface of the slider.

Other features of the technique of the present disclosure will be further apparent from an embodiment of the technique of the present disclosure as described below and the attached drawings.

According to the present wire regulator, the slider has the metal portion and the resin portion. The slit is provided at the resin portion at at least one of the front surface or the back surface of the slider. With this configuration, the thermal shrinkage amount difference between the members at the cooling step after or during insert molding is decreased, the difference being caused due to the difference in the coefficient of linear expansion between the resin member and the metal member. Thus, the internal stress difference between the members due to the thermal shrinkage amount difference is also decreased. Consequently, the resin portion is less crackable.

Other advantages effects of the technique of the present disclosure will be further apparent from the embodiment of the technique of the present disclosure as described below and the attached drawings.

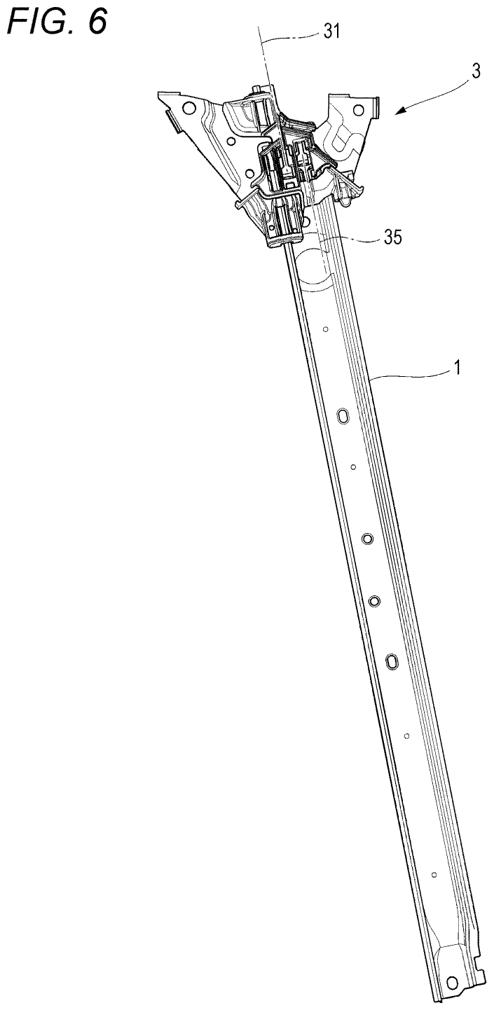

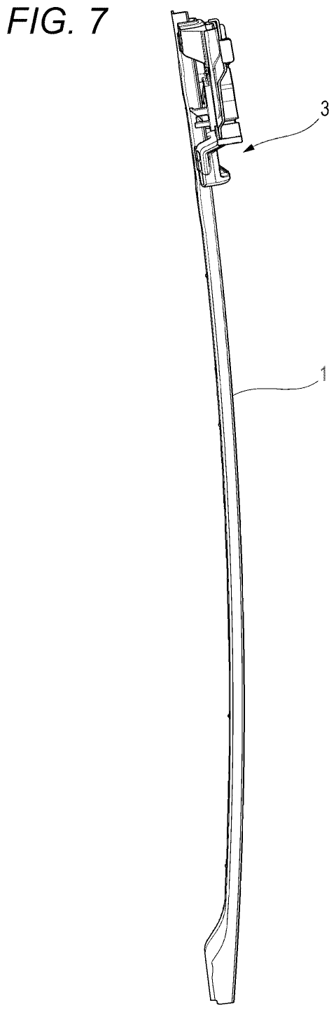

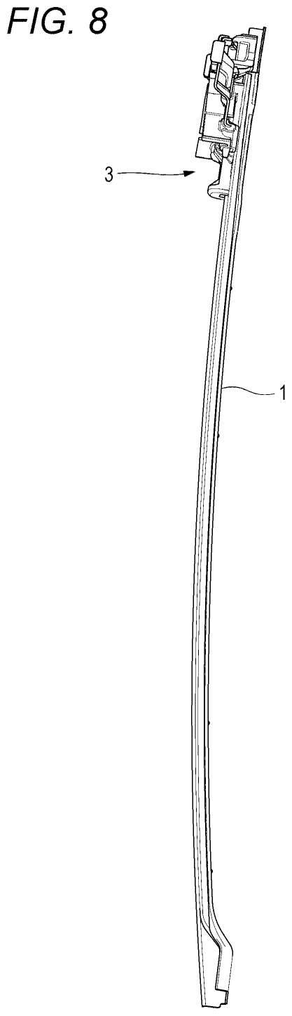

First, a wire regulator of the present embodiment will be described using FIGS. 6 to 8. FIG. 6 is a front view of a main portion of the wire regulator of the present embodiment. FIG. 7 is a left side view of the wire regulator illustrated in FIG. 6. FIG. 8 is a right side view of the wire regulator illustrated in FIG. 6.

In these figures, a guide rail 1 is provided at an inner panel of a door along a window glass lifting/lowering direction. A slider 3 holding a window glass movably engages with the guide rail 1.

One end portion of a lifting wire 31 extending upward of the slider 3 and one end portion of a lowering wire 35 extending downward of the slider 3 are locked at the slider 3.

The other end portion of the lifting wire 31 is wound around a not-shown drum. Moreover, the other end portion of the lowering wire 35 is wound around not-shown another drum. These drums are rotatably driven, and accordingly, the lowering wire 35 and the lifting wire 31 wound around the drums are drawn out of the drums or wound up around the drums. In this manner, the slider 3 lifts/lowers along the guide rail 1. That is, the slider 3 is lifted/lowered along the guide rail 1 by movement of the lifting wire 31 and the lowering wire 35 along the guide rail 1.

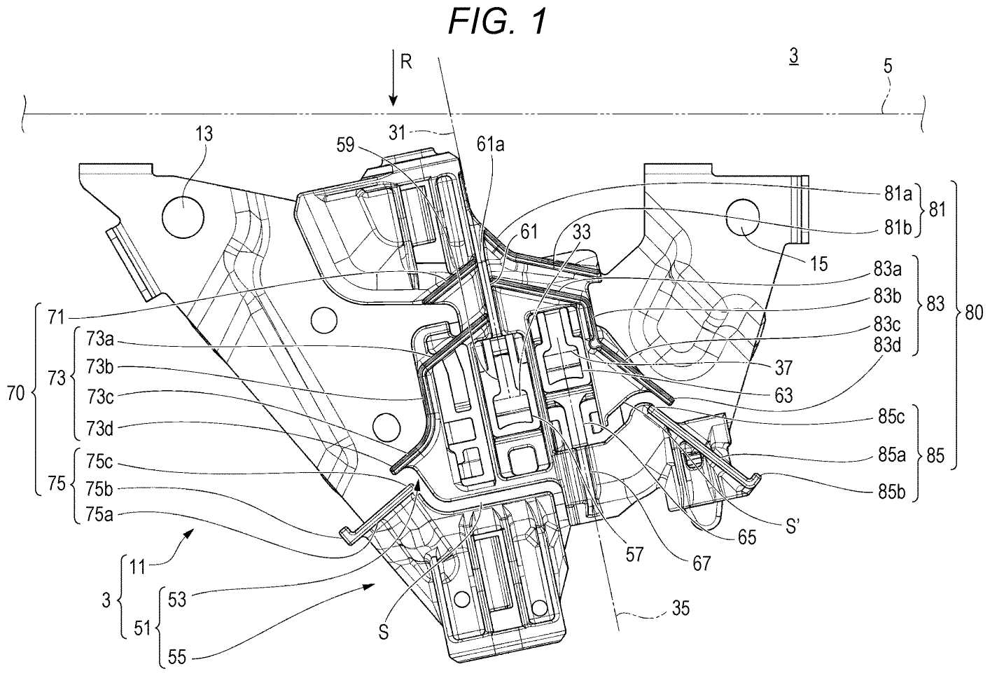

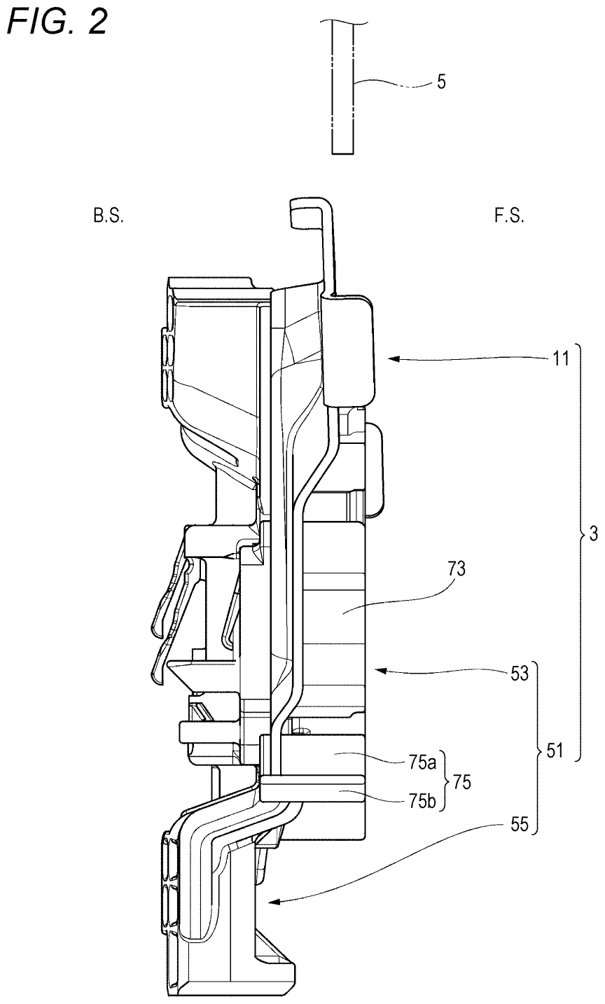

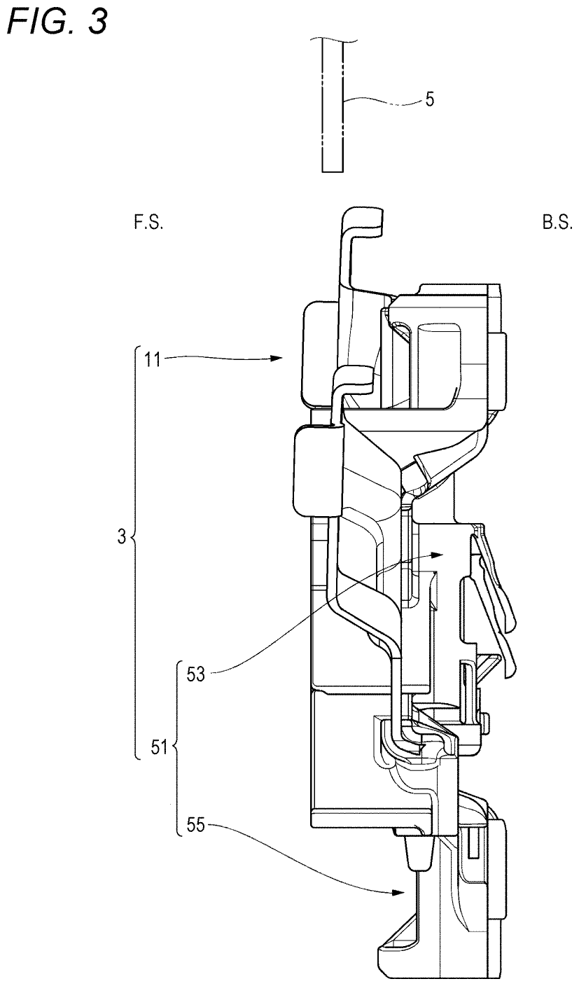

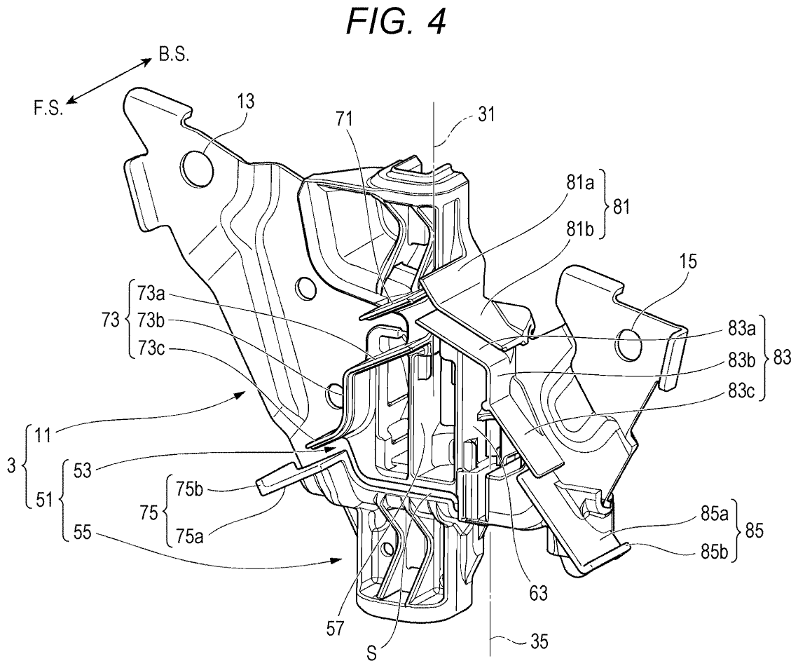

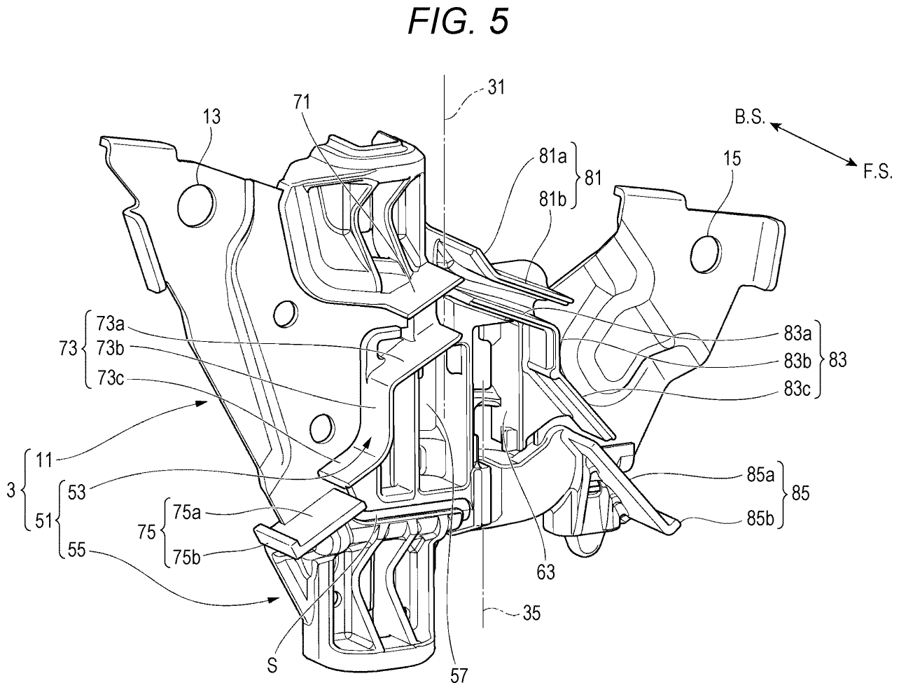

Next, the slider 3 will be described using FIGS. 1 to 5. FIG. 1 is an enlarged view of the slider illustrated in FIG. 6. FIG. 2 is a left side view of the slider illustrated in FIG. 1. FIG. 3 is a right side view of the slider illustrated in FIG. 1. FIG. 4 is a perspective view of the slider illustrated in FIG. 1 from the right side. FIG. 5 is a perspective view of the slider illustrated in FIG. 1 from the left side.

The slider 3 of the present embodiment is an insert molded article of a resin member and a metal member. The slider 3 is roughly divided into a plate-shaped metal portion 11 and a resin portion 51. The resin portion 51 covers part of a front surface F.S. (see FIGS. 2 and 3) and a back surface B.S. (see FIGS. 2 and 3) of the metal portion 11.

The resin portion 51 on a front surface F.S. side of the metal portion 11 is, through slit S and slit S′, divided into a first resin portion 53 positioned above and a second resin portion 55 positioned below.

The window glass 5 is arranged on an upper portion of the metal portion 11 through a bracket. Two holes 13, 15 to which the bracket is to be attached are formed at the metal portion 11.

A lifting wire end housing portion (a cable assembly portion) 57 is formed at the first resin portion 53 of the resin portion 51. A wire end 33 of the lifting wire 31 extending upward of the slider 3 is provided (locked) at the lifting wire end housing portion 57. The lifting wire 31 is biased in the direction of tightening the lifting wire 31 by a not-shown biasing section configured to bias the wire end 33. Further, a groove 61 (a lifting wire groove) for guiding the lifting wire 31 to the lifting wire end housing portion 57 is formed at the slider 3.

Note that a rainwater and the like dropping direction is indicated by an arrow in FIG. 1. The direction of extension of the groove 61 for guiding the lifting wire 31 to an upper portion of the slider 3 is a direction crossing the rainwater and the like dropping direction indicated by the arrow R.

Further, a lowering wire end housing portion (the cable assembly portion) 63 is formed at the first resin portion 53 of the resin portion 51. A wire end 37 of the lowering wire 35 extending downward of the slider 3 is provided (locked) at the lowering wire end housing portion 63. The lowering wire 35 is biased in the direction of tightening the lowering wire 35 by a not-shown biasing section configured to bias the wire end 37. Further, a groove 67 (a lowering wire groove) for guiding the lowering wire 35 to the lowering wire end housing portion 63 is formed at the slider 3. The direction of extension of the groove 67 for guiding the lowering wire 35 to a lower portion of the slider 3 is a direction crossing the rainwater and the like dropping direction indicated by the arrow R.

A rainwater guide portion (a first rainwater guide portion) 70 having multiple eaves (rain gutters) is provided on one side of the groove 61 for guiding the lifting wire 31. Moreover, a rainwater guide rail guide portion (a second rainwater guide portion) 80 is provided on the other side of the groove 61. That is, the resin portion 51 forms the rainwater guide portion 70 having the eaves on one side through the lifting wire 31, and forms the rainwater guide rail guide portion 80 having eaves on the other side. The rainwater guide portion 70 and the rainwater guide rail guide portion 80 reduce entrance of rainwater into the lifting wire end housing portion 57, the lowering wire end housing portion 63, and the grooves (groove portions) 61, 67.

First, the rainwater guide portion 70 will be described.

A first eave 71 is formed on one side of the groove 61 for guiding the lifting wire 31. The first eave 71 receives rainwater and the like dropping from the window glass 5. The first eave 71 is inclined downward along the direction of separating from the lifting wire 31. An upper end portion of the first eave 71 is adjacent to the groove 61. A second eave 73 is formed below the first eave 71. The second eave 73 has an overlapping portion 73a, a downwardly-extending portion 73b, and an inclined portion 73c. The overlapping portion 73a overlaps with the first eave 71 in the rainwater and the like dropping direction. That is, the rainwater guide portion 70 has two eaves (the first eave 71 and the second eave 73) overlapping with each other in the rainwater and the like dropping direction. The downwardly-extending portion 73b is provided continuously to a lower end portion of the overlapping portion 73a, and extends downward. The inclined portion 73c is provided continuously to a lower end portion of the downwardly-extending portion 73b. The inclined portion 73c is inclined downward along the direction of separating from the lifting wire end housing portion (the cable assembly portion) 57. Note that the first eave 71 and the second eave 73 are formed at the first resin portion 53.

Note that in the present embodiment, the first eave 71 and the second eave 73 are formed such that upper ends thereof are positioned higher than a lower end of the lifting wire end housing portion 57.

A third eave 75 is formed at the second resin portion 55. The third eave 75 has an inclined portion 75a and a standing wall portion (a terminal end portion) 75b. The inclined portion 75a is inclined downward along the direction of separating from the lifting wire end housing portion (the cable assembly portion) 57. The inclined portion 75a guides rainwater and the like to an edge portion (the outside with respect to a side portion of the guide rail 1 (see FIG. 6)) of the slider 3. The standing wall portion 75b is provided continuously to a lower end of the inclined portion 75a. The standing wall portion 75b protrudes upward of an upper surface of the inclined portion 75a, and extends to the back surface B.S. The standing wall portion 75b guides rainwater and the like to the back surface B.S. of the slider 3.

Further, a lower end portion 73d of the inclined portion 73c of the second eave 73 and an upper end portion 75c of the inclined portion 75a of the third eave 75 overlap with each other in the rainwater and the like dropping direction indicated by the arrow R.

That is, the eaves of the rainwater guide portion 70 are divided by the slit S. Thus, the second eave 73 and the third eave 75 are formed.

Next, the rainwater guide rail guide portion 80 will be described. An eleventh eave 81 is formed on the other side of the groove 61 for guiding the lifting wire 31. The eleventh eave 81 receives rainwater and the like dropping from the window glass 5. The eleventh eave 81 is inclined downward along the direction of separating from the lifting wire 31. An upper end portion of the eleventh eave 81 is adjacent to the groove 61.

The eleventh eave 81 has an upper-side first inclined portion 81a and a second inclined portion 81b. The second inclined portion 81b is provided continuously to a lower end portion of the first inclined portion 81a, and has a gentler inclination angle than the inclination angle of the first inclined portion 81a. Further, the eleventh eave 81 is formed higher than the first eave 71 in the rainwater and the like dropping direction R.

A twelfth eave 83 is formed below the eleventh eave 81. The twelfth eave 83 has an overlapping portion 83a, a downwardly-extending portion 83b, and an inclined portion 83c. The overlapping portion 83a overlaps with the eleventh eave 81 in the rainwater and the like dropping direction. That is, the rainwater guide rail guide portion 80 has two eaves (the eleventh eave 81 and the twelfth eave 83) overlapping with each other in the rainwater and the like dropping direction. The downwardly-extending portion 83b is provided continuously to a lower end portion of the overlapping portion 83a, and extends downward. The inclined portion 83c is provided continuously to a lower end portion of the downwardly-extending portion 83b. The inclined portion 83c is inclined downward along the direction of separating from the lowering wire end housing portion (the cable assembly portion) 63. Further, the twelfth eave 83 is formed higher than the second eave 73 in the rainwater and the like dropping direction R.

A thirteenth eave 85 for receiving rainwater and the like dropping from a lower end of the twelfth eave 83 is formed below the twelfth eave 83. The thirteenth eave 85 is inclined downward along the direction of separating from the lowering wire end housing portion (the cable assembly portion) 63. The thirteenth eave 85 has an inclined portion 85a and a standing wall portion (a terminal end portion) 85b. The inclined portion 85a guides rainwater and the like to the edge portion (the outside with respect to the side portion of the guide rail 1 (see FIG. 6)) of the slider 3. The standing wall portion 85b is provided continuously to a lower end of the inclined portion 85a. The standing wall portion 85b protrudes upward of an upper surface of the inclined portion 85a, and extends to the back surface B.S. The standing wall portion 85b guides rainwater and the like to contact the back surface of the guide rail 1. Note that the eleventh eave 81 and the twelfth eave 83 are formed at the first resin portion 53. Moreover, the thirteenth eave 85 is formed at the second resin portion 55. Further, the thirteenth eave 85 is formed higher than the third eave 75 in the rainwater and the like dropping direction R.

That is, the eaves of the rainwater guide rail guide portion 80 are divided by the slit S′. Thus, the twelfth eave 83 and the thirteenth eave 85 are formed.

Note that in the present embodiment, the eleventh eave 81 and the twelfth eave 83 are formed such that upper ends thereof are positioned higher than a lower end of the lifting wire end housing portion 57.

According to the above-described configuration, the following advantageous effects are obtained.

(1) The slider 3 is the insert molded article of the resin member and the metal member. The slider 3 is roughly divided into the plate-shaped metal portion 11 and the resin portion 51. The resin portion 51 covers part of the front surface F.S. and the back surface B.S. of the metal portion 11.

The resin portion 51 on the front surface F.S. side of the metal portion 11 is, through the slit S and the slit S′, divided into the first resin portion 53 positioned above and the second resin portion 55 positioned below.

Thus, a thermal shrinkage amount difference between the members at a cooling step after or during insert molding is decreased, the difference being caused due to a difference in the coefficient of linear expansion between the resin portion 51 and the metal portion 11. Thus, an internal stress difference between the members due to the thermal shrinkage amount difference is also decreased. Consequently, the resin portion 51 is less crackable.

(2) The second eave 73 and the third eave 75 divided by the slit S are configured such that the lower end portion 73d of the inclined portion 73c of the second eave 73 and the upper end portion 75c of the inclined portion 75a of the third eave 75 overlap with each other in the rainwater and the like dropping direction indicated by the arrow R. That is, the second eave 73 and the third eave 75 divided from each other partially overlap with each other in the rainwater and the like dropping direction. Thus, rainwater and the like flowing on an upper surface of the second eave 73 are less likely to drop onto the slit S, and are more likely to move onto an upper surface of the third eave 75. Consequently, such rainwater and the like can be guided to the edge portion (the outside with respect to the side portion of the guide rail 1) of the slider 3.

The twelfth eave 83 and the thirteenth eave 85 divided by the slit S′ are configured such that a lower end portion 83d of the inclined portion 83c of the twelfth eave 83 and an upper end portion 85c of the inclined portion 85a of the thirteenth eave 85 overlap with each other in the rainwater and the like dropping direction indicated by the arrow R. That is, the twelfth eave 83 and the thirteenth eave 85 divided from each other partially overlap with each other in the rainwater and the like dropping direction. Thus, rainwater and the like flowing on an upper surface of the twelfth eave 83 are less likely to drop onto the slit S′, and are more likely to move onto an upper surface of the thirteenth eave 85. Consequently, such rainwater and the like can be guided to the edge portion (the outside with respect to the side portion of the guide rail 1) of the slider 3.

Note that it may only be required that the slit S and the slit S′ are provided at the resin portion 51 at at least one of the front surface or the back surface of the slider 3.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A wire regulator comprising:
a guide rail along a window glass lifting/lowering direction;
a slider attached to a window glass and movably engaging with the guide rail;
a lifting wire locked at the slider at one end and extending upward of the slider; and
a lowering wire locked at the slider at one end and extending downward of the slider,
wherein the slider is lifted/lowered along the guide rail by movement of the lifting wire and the lowering wire along the guide rail,
the slider has a metal portion and a resin portion,
the resin portion
covers part of a front surface and a back surface of the metal portion, and
forms a rainwater guide portion having an eave, the rainwater guide portion reducing entrance of rainwater into a lifting wire end housing portion, a lowering wire end housing portion, and a groove portion, and
a slit is provided at the resin portion at at least one of a front surface or a back surface of the slider.

2. The wire regulator according to claim 1, wherein
the eave of the rainwater guide portion is divided into two eaves by the slit, and
the two divided eaves partially overlap with each other in a rainwater and the like dropping direction.

3. The wire regulator according to claim 1, wherein
the resin portion forms the rainwater guide portion on one side through the lifting wire, and forms a second rainwater guide portion having an eave on the other side,
the eave of the second rainwater guide portion is divided by the slit, and
the divided eaves partially overlap with each other in the rainwater and the like dropping direction.

4. The wire regulator according to claim 3, wherein
an upper end portion of the upper eave of the rainwater guide portion and an upper end portion of the upper eave of the second rainwater guide portion are provided adjacent to a groove through which the lifting wire passes.

5. The wire regulator according to claim 2, wherein
the resin portion forms the rainwater guide portion on one side through the lifting wire, and forms a second rainwater guide portion having an eave on the other side,
the eave of the second rainwater guide portion is divided by the slit, and
the divided eaves partially overlap with each other in the rainwater and the like dropping direction.

6. The wire regulator according to claim 5, wherein
an upper end portion of the upper eave of the rainwater guide portion and an upper end portion of the upper eave of the second rainwater guide portion are provided adjacent to a groove through which the lifting wire passes.
